(19) United States
(12) Patent Application Publication
(10) Pub. No.: US 2019/0054926 A1
(43) Pub. Date: Feb. 21, 2019

(54) AUTONOMOUS DRIVING VEHICLE

(71) Applicant: TOYOTA JIDOSHA KABUSHIKI KAISHA, Toyota-shi (JP)

(72) Inventor: Masaki WASEKURA, Toyota-shi (JP)

(73) Assignee: TOYOTA JIDOSHA KABUSHIKI KAISHA, Toyota-shi (JP)

(21) Appl. No.: 16/014,297

(22) Filed: Jun. 21, 2018

(30) Foreign Application Priority Data
Aug. 21, 2017 (JP) 2017-158511

(51) Int. Cl. B60W 50/12; B60W 50/10; B60W 10/30; B60W 40/08; B60W 50/14; B60R 22/48

(52) U.S. Cl. CPC B60W 50/12; B60W 50/10; B60W 10/30; B60R 2022/4891; B60W 50/14; B60R 22/48; B60W 2040/0809; B60W 40/08

(57) ABSTRACT

An autonomous driving vehicle, which provides a driverless transportation service, includes: an authentication device that performs authentication of a user in the autonomous driving vehicle; an intention receiving device that receives information indicating intention of the user in the autonomous driving vehicle; and a control device that controls the autonomous driving vehicle. When maneuvering the autonomous driving vehicle to depart to a destination, the control device performs departure condition confirmation processing that prohibits the autonomous driving vehicle from departing until a departure condition is satisfied and permits the autonomous driving vehicle to depart when the departure condition is satisfied. The departure condition includes: a first condition that the authentication of the user by the authentication device is completed; and a second condition that the intention receiving device receives departure intention information indicating departure intention of the user.

### BACKGROUND

### Technical Field

The present disclosure relates to an autonomous driving vehicle providing a driverless transportation service.

### Background Art

Patent Literature 1 discloses a driverless transportation service using an autonomous driving vehicle that is capable of driving without a human driver. The autonomous driving vehicle heads to a pickup location for picking up a user. On arriving at the pickup location, the autonomous driving vehicle stops and opens a door. The user gets in the autonomous driving vehicle and holds a membership card over an authentication unit. The autonomous driving vehicle performs authentication of the user by checking the information read from the membership card against membership information registered beforehand. When the authentication of the user is completed, the autonomous driving vehicle closes the door and locks the door. After that, the autonomous driving vehicle determines whether or not the user wears a seat belt. When the wearing of the seat belt is detected, the autonomous driving vehicle departs and autonomously travels toward a destination.

### LIST OF RELATED ART

Patent Literature 1: Japanese Laid-Open Patent Publication No. 2015-191264

### SUMMARY

According to the conventional technique disclosed in Patent Literature 1, the door of the autonomous driving vehicle is automatically locked when the authentication of the user is completed. After that, when the wearing of the seat belt is detected, the autonomous driving vehicle departs. The conventional technique does not consider intention and circumstances of the user. Therefore, there is a possibility that the autonomous driving vehicle arbitrarily departs (i.e. starts moving) even if the user is not ready for departure.

For example, there is a case where the user once takes a seat, wears the seat belt, and thereafter desires to change the seat. As another example, there is a case where the user takes a seat, wears the seat belt, and thereafter tries to place a cup with a drink in a stable position. In these cases, the autonomous driving vehicle arbitrarily departs although the user is not ready for departure. The user feels senses of strangeness and inconvenience with respect to such the arbitrary departure of the autonomous driving vehicle. This causes decrease in confidence in the autonomous driving vehicle and the driverless transportation service.

In a case where there are a plurality of users, the following situation may occur. That is, a part of the users puts baggage in a trunk outside the vehicle, while another user performs an authentication operation in the vehicle. In this case, the door is automatically locked before all the users ride in the vehicle. Furthermore, if the user performing the authentication operation in the vehicle wears the seat belt, the autonomous driving vehicle arbitrarily departs with leaving the other users outside the vehicle. This also causes decrease in confidence in the autonomous driving vehicle and the driverless transportation service.

An object of the present disclosure is to provide a technique that can reduce user's senses of strangeness and inconvenience when an autonomous driving vehicle providing a driverless transportation service departs.

A first disclosure provides an autonomous driving vehicle that provides a driverless transportation service.

The autonomous driving vehicle includes:

an authentication device that performs authentication of a user in the autonomous driving vehicle;

an intention receiving device that receives information indicating intention of the user in the autonomous driving vehicle; and

a control device that controls the autonomous driving vehicle.

When maneuvering the autonomous driving vehicle to depart to a destination, the control device performs departure condition confirmation processing that prohibits the autonomous driving vehicle from departing until a departure condition is satisfied and permits the autonomous driving vehicle to depart when the departure condition is satisfied.

The departure condition includes:

a first condition that the authentication of the user by the authentication device is completed; and

a second condition that the intention receiving device receives departure intention information indicating departure intention of the user.

A second disclosure further has the following feature in addition to the first disclosure.

The control device automatically locks a door of the autonomous driving vehicle before departure, in response to both the first condition and the second condition being satisfied.

A third disclosure further has the following feature in addition to the first disclosure.

The autonomous driving vehicle further has a door lock detection device that detects that a door of the autonomous driving vehicle is locked.

The departure condition further includes a third condition that the door lock detection device detects that the door is locked.

The control device urges the user to lock the door when the third condition is not satisfied.

A fourth disclosure further has the following feature in addition to any one of the first to third disclosures.

The autonomous driving vehicle further has a seat belt detection device that detects that the user wears a seat belt of a seat on which the user sits.

The departure condition further includes a fourth condition that the seat belt detection device detects that the user wears the seat belt.

A fifth disclosure further has the following feature in addition to the fourth disclosure.

Exemption request intention information indicates intention of the user to request exemption of the fourth condition because the user cannot wear the seat belt for the user reason.

The control device excludes the fourth condition from the departure condition when the intention receiving device receives the exemption request intention information.

A sixth disclosure further has the following feature in addition to any one of the first to fifth disclosures.

A number of the user is plural.

The plurality of users include a representative user.

The first condition is that the authentication of the representative user by the authentication device is completed.

The second condition is that the intention receiving device receives the departure intention information from the representative user.

A seventh disclosure further has the following feature in addition to the sixth disclosure.

The control device performs the departure condition confirmation processing again when maneuvering the autonomous driving vehicle to depart again after a part of the plurality of users gets off before a final destination.

According to the first disclosure, the departure condition for permitting the autonomous driving vehicle to depart includes the first condition and the second condition. The second condition among them is for confirming explicit departure intention of the user. It is thus possible to prevent the autonomous driving vehicle from arbitrarily departing before the user becomes ready for departure. As a result, the user's senses of strangeness and inconvenience when the autonomous driving vehicle departs are reduced. This contributes to increase in confidence in the autonomous driving vehicle and the driverless transportation service.

According to the second disclosure, the door is automatically locked in response to both the first condition and the second condition being satisfied. That is, it is after confirmation of the departure intention of the user that the door is automatically locked. Therefore, the door is prevented from being locked when the user in the vehicle is going to once get out the vehicle or when a part of the users is still outside of the vehicle. This also contributes to increase in confidence in the autonomous driving vehicle and the driverless transportation service.

According to the third disclosure, the user can lock the door on the user's own will. Therefore, the door is prevented from being locked when the user in the vehicle is going to once get out the vehicle or when a part of the users is still outside of the vehicle.

According to the fourth disclosure, the fourth condition that the user wears the seat belt is added to the departure condition. As a result, safety of the user increases.

According to the fifth disclosure, it is possible to exempt the user from the fourth condition if the user cannot wear the seat belt for the user reason. As a result, convenience is improved.

According to the sixth disclosure, when there are a plurality of users, it is enough to confirm that the first condition and the second condition are satisfied with regard only to the representative user, instead of all the users.

According to the seventh disclosure, the departure condition confirmation processing is performed also when a part of the plurality of users gets off along the way and then the autonomous driving vehicle departs again. As a result, the above-describe effects can be obtained also when the autonomous driving vehicle departs again.

### BRIEF DESCRIPTION OF DRAWINGS

FIG. 1 is a block diagram schematically showing a configuration example of an autonomous driving vehicle according to a first embodiment of the present disclosure;

FIG. 2 is a conceptual diagram for explaining departure condition confirmation processing by the autonomous driving vehicle according to the first embodiment;

FIG. 3 is a flow chart showing an example of the departure condition confirmation processing by the autonomous driving vehicle according to the first embodiment;

FIG. 4 is a flow chart showing processing by the autonomous driving vehicle in the vicinity of a destination according to the first embodiment;

FIG. 5 is a flow chart showing an example of the departure condition confirmation processing by the autonomous driving vehicle according to a second embodiment of the present disclosure;

FIG. 6 is a block diagram schematically showing a configuration example of the autonomous driving vehicle according to a third embodiment of the present disclosure;

FIG. 7 is a flow chart showing an example of the departure condition confirmation processing by the autonomous driving vehicle according to the third embodiment;

FIG. 8 is a flow chart showing Step S40 (fourth condition confirmation processing) in a fourth embodiment of the present disclosure; and

FIG. 9 is a flow chart showing processing by the autonomous driving vehicle in the vicinity of a destination according to a fifth embodiment of the present disclosure.

### EMBODIMENTS

Embodiments of the present disclosure will be described below with reference to the attached drawings.

### 1. First Embodiment

### 1-1. Driverless Transportation Service

A first embodiment relates to a driverless transportation service using an autonomous driving vehicle that is capable of driving without a human driver. A basic flow of the driverless transportation service is as follows.

First, a user uses a user terminal (e.g. a smartphone) to send a dispatch request to a management center. The dispatch request includes ID information of the user or the user terminal, a pickup location at which the user desires to be picked up, and so forth. The dispatch request is transmitted to a management server of the management center through a communication network. The management server selects an autonomous driving vehicle that provides the service, and transmits information of the dispatch request to the selected autonomous driving vehicle. The autonomous driving vehicle automatically heads to the pickup location.

The autonomous driving vehicle arrives at the pickup location and stops. The user takes a ride in the autonomous driving vehicle. The autonomous driving vehicle performs authentication of the user by using the ID information included in the dispatch request. The user notifies the autonomous driving vehicle of a destination. Alternatively, the information of the destination may be included in the dispatch request. The autonomous driving vehicle autonomously travels toward the destination. The autonomous driving vehicle arrives at the destination and stops. The user gets off the autonomous driving vehicle.

Hereinafter, the autonomous driving vehicle according to the present embodiment will be described in detail.

### 1-2. Configuration Example of Autonomous Driving Vehicle

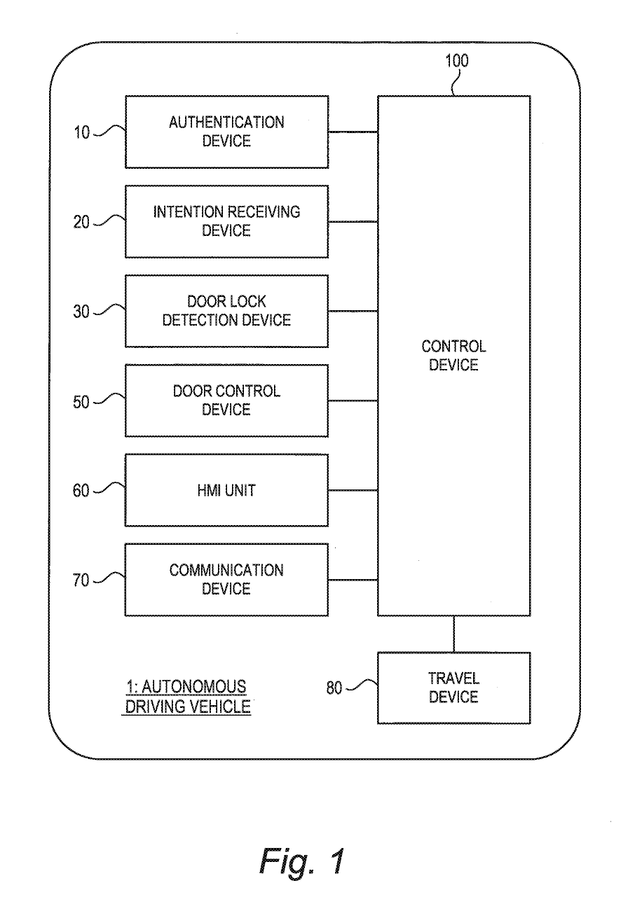

FIG. 1 is a block diagram schematically showing a configuration example of an autonomous driving vehicle 1 according to the present embodiment. The autonomous driving vehicle 1 is capable of driving without a human driver and provides the driverless transportation service. As shown in FIG. 1, the autonomous driving vehicle 1 is provided with an authentication device 10, an intention receiving device 20, a door lock detection device 30, a door control device 50, an HMI (Human Machine Interface) unit 60, a communication device 70, a travel device 80, and a control device 100.

The authentication device 10 performs authentication of the user in the autonomous driving vehicle 1. The authentication device 10 holds the ID information of the user or the user terminal included in the dispatch request, and performs authentication processing based on the ID information.

For example, the authentication device 10 includes a communication device. In this case, the user uses the user terminal to communicate with the authentication device 10 and request authentication. The authentication device 10 communicates with the user terminal and performs the authentication processing based on the ID information of the user or the user terminal. It should be noted that a communication method whose effective communication range is limited within the autonomous driving vehicle 1, such as WiFi, is used in this example.

As another example, the authentication device 10 includes a card reader. In this case, the user uses an IC card or a magnetic card in which the ID information of the user is recorded. More specifically, the user holds the IC card over a reading surface of the authentication device 10 (i.e. an IC card reader) or slides the magnetic card through a reading groove of the authentication device 10 (i.e. a magnetic card reader). The authentication device 10 reads the ID information of the user from the IC card or the magnetic card to perform the authentication processing.

The intention receiving device 20 receives intention information indicating “intention” of the user in the autonomous driving vehicle 1.

For example, the intention receiving device 20 includes a communication device. In this case, the user uses the user terminal to transmit intention information indicating the user's intention to the intention receiving device 20. The intention receiving device 20 receives the intention information transmitted from the user terminal. It should be noted that a communication method whose effective communication range is limited within the autonomous driving vehicle 1, such as WiFi, is used in this example.

As another example, the intention receiving device 20 includes an input device located in the autonomous driving vehicle 1. The input device is exemplified by a touch panel, a switch, and a button. The user uses the input device to input intention information indicating the user's intention. The intention receiving device 20 receives the intention information input by the user.

As still another example, the intention receiving device 20 includes a microphone and a speech recognition device. In this case, the user notifies the user's intention by speech. That is, the intention information is speech information. The speech information (intention information) is input to the speech recognition device through the microphone. The speech recognition device analyzes the speech information to recognize the user's intention.

The door lock detection device 30 is a sensor that detects that a door of the autonomous driving vehicle 1 is locked.

The door control device 50 automatically opens/closes the door of the autonomous driving vehicle 1. Moreover, the door control device 50 automatically locks/unlocks the door of the autonomous driving vehicle 1.

The HMI unit 60 is an interface for proving the user with information and receiving information from the user. For example, the HMI unit 60 includes a display device, a speaker, an input device, and a microphone. The HMI unit 60 can notify the user of a variety of information through the display device and the speaker. The input device is exemplified by a touch panel, a switch, and a button. The user can input a variety of information to the HMI unit 60 by using the input device and the microphone. It should be noted that the above-described intention receiving device 20 may be a part of the HMI unit 60.

The communication device 70 communicates with the outside of the autonomous driving vehicle 1. More specifically, the communication device 70 communicates with the management server of the management center through a communication network. Moreover, the communication device 70 communicates with the user terminal through a communication network. Furthermore, the communication device 70 may perform V2X communication (i.e. a vehicle-to-vehicle communication and a vehicle-to-infrastructure communication) with surrounding vehicles and a roadside infrastructure. The communication device 70 is also called a DCM (Data Communication Module).

The travel device 80 includes a steering device, a driving device, and a braking device. The steering device turns wheels. The driving device is a power source that generates a driving force. The driving device is exemplified by an engine and an electric motor. The braking device generates a braking force.

The control device 100 controls the autonomous driving vehicle 1. In particular, the control device 100 controls the driverless transportation service provided by the autonomous driving vehicle 1. For example, the control device 100 controls the travel device 80 to control the travel of the autonomous driving vehicle 1. Typically, the control device 100 is a microcomputer including a processor, a memory, and an input/output interface. The control device 100 is also called an ECU (Electronic Control Unit).

### 1-3. Departure Condition Confirmation Processing

A period from when the autonomous driving vehicle 1 arrives at the pickup location until when the autonomous driving vehicle 1 departs to the destination is hereinafter referred to as a “boarding procedure period”. In the boarding procedure period, the user gets in the autonomous driving vehicle 1 and prepares for departure of the autonomous driving vehicle 1.

However, since the autonomous driving vehicle 1 basically operates automatically, there is a possibility that the autonomous driving vehicle 1 arbitrarily departs (i.e. starts moving) before the user becomes ready for departure. In other words, there is a possibility that the autonomous driving vehicle 1 arbitrarily departs without considering intention and circumstances of the user. The user feels senses of strangeness and inconvenience with respect to such the arbitrary departure of the autonomous driving vehicle 1. This causes decrease in confidence in the autonomous driving vehicle 1 and the driverless transportation service.

In view of the above, according to the present embodiment, a “departure condition” for permitting the autonomous driving vehicle 1 to depart is defined in consideration of the intention of the user. When maneuvering the autonomous driving vehicle 1 to depart to the destination, the control device 100 of the autonomous driving vehicle 1 determines whether or not the departure condition is satisfied. The control device 100 prohibits the autonomous driving vehicle 1 from departing until the departure condition is satisfied. When the departure condition is satisfied, the control device 100 permits the autonomous driving vehicle 1 to depart. Such the processing is hereinafter referred to as “departure condition confirmation processing”.

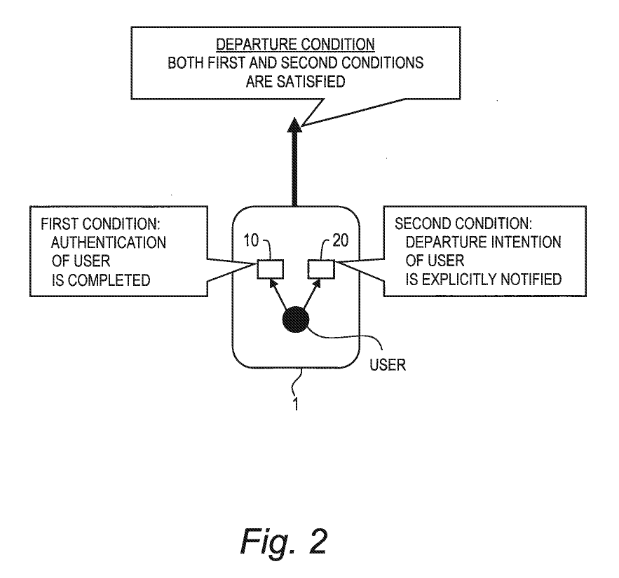

FIG. 2 is a conceptual diagram for explaining the departure condition in the departure condition confirmation processing according to the present embodiment. According to the present embodiment, the departure condition includes the following two conditions.

(1) First condition: the authentication of the user by the authentication device 10 is completed (i.e. validated).

(2) Second condition: departure intention of the user is “explicitly” notified to the autonomous driving vehicle 1, that is, the intention receiving device 20 receives departure intention information indicating departure intention of the user.

The first condition is a condition for confirming that a human who gets in the autonomous driving vehicle 1 is truly the user who has requested the service. The second condition is a condition for confirming the explicit departure intention of the user. When both the first condition and the second condition are satisfied, the control device 100 determines that the departure condition is satisfied and thus permits the autonomous driving vehicle 1 to depart.

It should be noted that the authentication device 10 and the intention receiving device 20 are available only for the user who is present in the autonomous driving vehicle 1, as described above. The reason is to prevent someone outside of the autonomous driving vehicle 1 from erroneously or maliciously satisfying the first condition and the second condition.

According to the present embodiment, as described above, the departure condition for permitting the autonomous driving vehicle 1 to depart includes the first condition and the second condition. The second condition among them is for confirming the explicit departure intention of the user. It is thus possible to prevent the autonomous driving vehicle 1 from arbitrarily departing before the user becomes ready for departure. As a result, the user's senses of strangeness and inconvenience when the autonomous driving vehicle 1 departs are reduced. This contributes to increase in confidence in the autonomous driving vehicle 1 and the driverless transportation service.

### 1-4. Example of Departure Condition Confirmation Processing

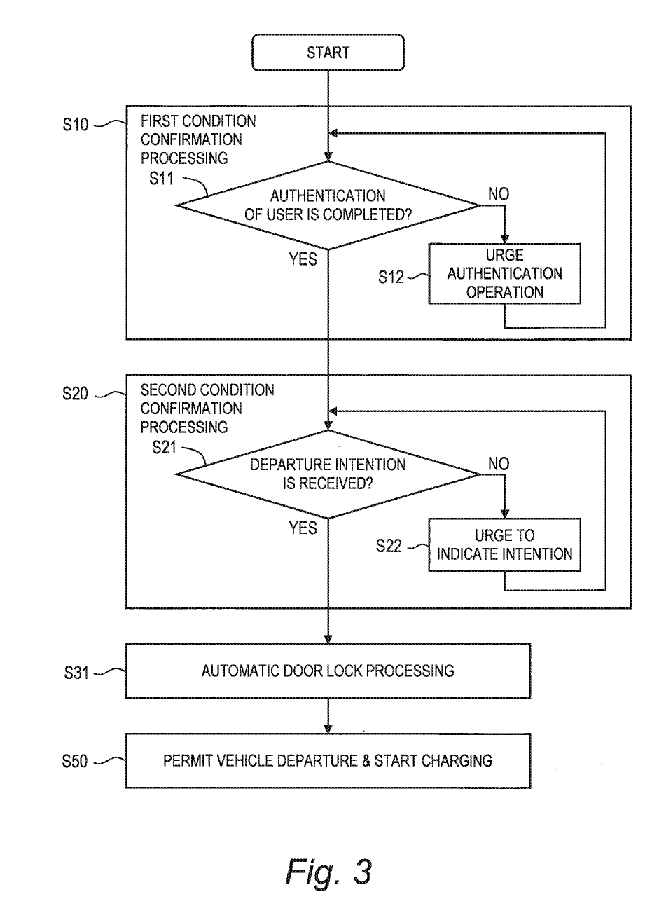

FIG. 3 is a flow chart showing an example of the departure condition confirmation processing according to the present embodiment.

### Step S10: First Condition Confirmation Processing

In Step S10, the control device 100 confirms that the first condition is satisfied. More specifically, the control device 100 determines whether or not the authentication of the user by the authentication device 10 is completed (Step S11). If the authentication is not yet completed (Step S11; No), the control device 100 urges, through the HMI unit 60 (e.g. display device, speaker), the user to perform a predetermined authentication operation (Step S12).

For example, the user uses the user terminal to communicate with the authentication device 10 and request the authentication. Alternatively, the user holds the IC card or the magnetic card over the authentication device 10. The authentication device 10 performs the authentication of the user based on the ID information of the user or the user terminal. In a case where the number of the user is plural, a representative user performs the predetermined authentication operation, and the authentication device 10 performs the authentication of the representative user. When the authentication of the user is completed, that is, when the first condition is satisfied (Step S11; Yes), the processing proceeds to Step S20.

### Step S20; Second Condition Confirmation Processing

In Step S20, the control device 100 confirms that the second condition is satisfied. More specifically, the control device 100 determines whether or not the intention receiving device 20 receives the departure intention information indicating the departure intention of the user (Step S21). If the intention receiving device 20 does not yet received the departure intention information (Step S21; No), the control device 100 urges, through the HMI unit 60 (e.g. display device, speaker), the user to indicate the departure intention (Step S22).

When the user completes preparations such as loading baggage, taking a seat, and so forth and thinks that it is safe to make the autonomous driving vehicle 1 depart, the user indicates the departure intention. For example, the user uses the user terminal to transmit the departure intention information indicating the departure intention. As another example, the user uses the in-card input device to input the departure intention information indicating the departure intention. As still another example, the user pronounces a predetermined message (e.g. “departure OK”) as the departure intention information. In the case where the number of the user is plural, the representative user indicates the departure intention. When the intention receiving device 20 receives the departure intention information, that is, when the second condition is satisfied (Step S21; Yes), the processing proceeds to Step S31.

### Step S31: Automatic Door Lock Processing

The control device 100 actuates the door control device 50 to automatically lock the door. After that, the processing proceeds to Step S50. It should be noted that Step S31 may be skipped if the user has already locked the door manually and the door being locked is detected by the door lock detection device 30.

### Step S50:

When it is confirmed by the above-described processing that the departure condition is satisfied, the control device 100 permits the autonomous driving vehicle 1 to depart. Moreover, the control device 100 starts charging. The control device 100 controls the travel device 80 to make the autonomous driving vehicle 1 depart (i.e. start moving).

In the case of the flow shown in FIG. 3, Step S31 is performed after Steps S10 and S20, that is, after both the first condition and the second condition are satisfied. Ii order to explain effects achieved by this sequence, let us first consider the following comparative example.

In the comparative example, Step S31 is performed between Step S10 and Step S20. In this case, the control device 100 automatically locks the door immediately after the authentication of the user is completed. However, there may be a situation where the user plans to put baggage in a trunk after performing the authentication operation. As another example, there may be a situation where a representative user performs the authentication operation while another user puts baggage in a trunk. Therefore, it is not preferable to automatically lock the door immediately after the authentication of the user is completed.

According to the present embodiment, the control device 100 automatically locks the door, if the door is not yet locked after the first condition and the second condition are satisfied. In other words, the control device 100 automatically locks the door before departure, in response to both the first condition and the second condition being satisfied. It is after confirmation of the departure intention of the user that the door is automatically locked. Therefore, the problem in the case of the above-mentioned comparative example is not caused. This also contributes to increase in confidence in the autonomous driving vehicle 1 and the driverless transportation service.

### 1-5. Processing Flow in Vicinity of Destination

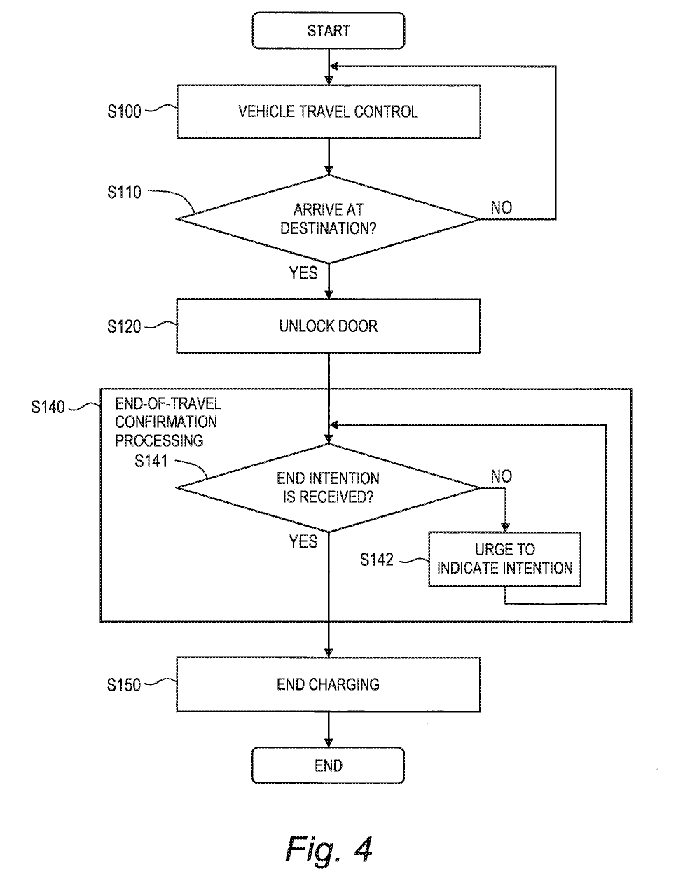

FIG. 4 is a flow chart showing processing by the autonomous driving vehicle 1 in the vicinity of the destination according to the present embodiment.

### Steps S100 and S110:

The control device 100 controls the travel device 80 to control travel of the autonomous driving vehicle 1 (Step S100). When the autonomous driving vehicle 1 arrives at the destination (Step S110; Yes), the processing proceeds to Step S120.

### Step S120:

The control device 100 actuates the door control device 50 to automatically unlock the door.

### Step S140: End-of-Travel Confirmation Processing

The user prepares to get off, confirms that there is nothing left behind, and then indicates end intention. For example, the user uses the user terminal to transmit end intention information indicating the end intention. As another example, the user uses the in-card input device to input the end intention information indicating the end intention. As still another example, the user pronounces a predetermined message (e.g. “end of use”) as the end intention information. In the case where the number of the user is plural, the representative user indicates the end intention.

The control device 100 performs end-of-travel confirmation processing. More specifically, the control device 100 determines whether or not the intention receiving device 20 receives the end intention information indicating the end intention of the user (Step S141). If the intention receiving device 20 does not yet received the end intention information (Step S141; No), the control device 100 urges, through the HMI unit 60, the user to indicate the end intention (Step S142). When the intention receiving device 20 receives the end intention information (Step S141; Yes), the processing proceeds to Step S150.

### Step S150:

In response to the indication of the end intention by the user, the control device 100 ends charging. After that, the control device 100 follows an instruction from the management server of the management center.

### 1-6. Effects

According to the present embodiment, as described above, the departure condition for permitting the autonomous driving vehicle 1 to depart includes the first condition and the second condition. The second condition among them is for confirming the explicit departure intention of the user. It is thus possible to prevent the autonomous driving vehicle 1 from arbitrarily departing before the user becomes ready for departure. As a result, the user's senses of strangeness and inconvenience when the autonomous driving vehicle 1 departs are reduced. This contributes to increase in confidence in the autonomous driving vehicle 1 and the driverless transportation service.

Moreover, according to the present embodiment, the door is automatically locked in response to both the first condition and the second condition being satisfied. That is, it is after confirmation of the departure intention of the user that the door is automatically locked. Therefore, the door is prevented from being locked when the user in the vehicle is going to once get out the vehicle or when a part of the users is still outside of the vehicle. This also contributes to increase in confidence in the autonomous driving vehicle 1 and the driverless transportation service.

### 2. Second Embodiment

In a second embodiment, the door of the autonomous driving vehicle 1 is locked in accordance with the user's intention. Accordingly, the departure condition further includes the following third condition in addition to the first condition and the second condition described above.

(3) Third condition: the door lock detection device 30 detects that the door of the autonomous driving vehicle 1 is locked.

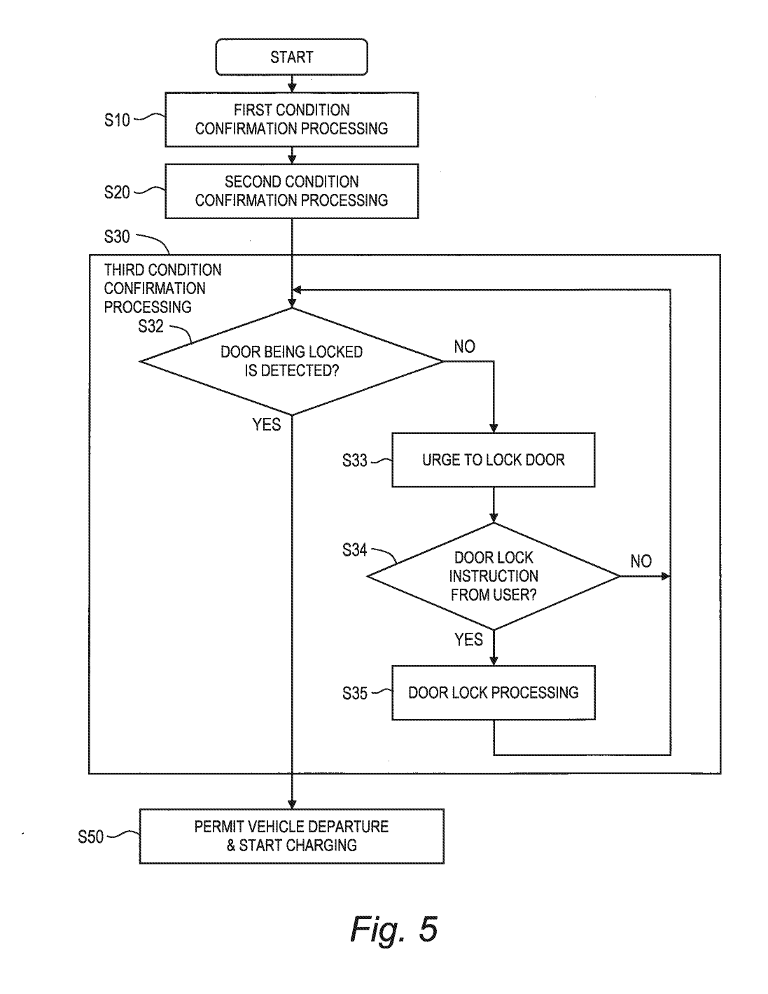

FIG. 5 is a flow chart showing an example of the departure condition confirmation processing according to the present embodiment. Step S30 (third condition confirmation processing) is added to the flow shown in the foregoing FIG. 3. An overlap description with the above-described first embodiment will be omitted as appropriate.

### Step S30: Third Condition Confirmation Processing

In Step S30, the control device 100 confirms that the third condition is satisfied. More specifically, the control device 100 determines whether or not the door being locked is detected by the door lock detection device 30 (Step S32). If the door is not yet locked (Step S32; No), the control device 100 urges, through the HMI unit 60 (e.g. display device, speaker), the user to lock the door (Step S33).

When judging that it's time to lock the door, the user manually locks the door. As a result, the door being locked is detected (Step S32; Yes), and thus the third condition is satisfied.

The user may use the intention receiving device 20 or the HMI unit 60 (e.g. input device, microphone) to instruct to lock the door. If a door lock instruction is input from the user (Step S34; Yes), the control device 100 actuates the door control device 50 to automatically lock the door (Step S35). As a result, the door being locked is detected (Step S32; Yes), and thus the third condition is satisfied.

According to the present embodiment, as described above, the user can lock the door on the user's own will. Therefore, the door is prevented from being locked when the user in the vehicle is going to once get out the vehicle or when a part of the users is still outside of the vehicle.

It should be noted that Step S30 may be performed between Step S20 and Step S50, or between Step S10 and Step S20.

### 3. Third Embodiment

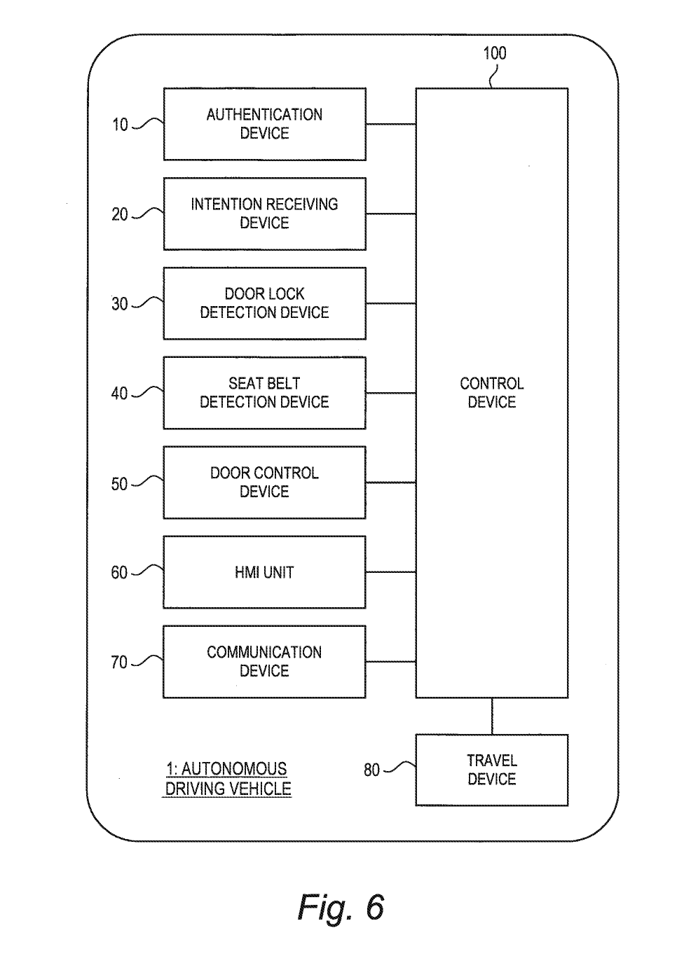

FIG. 6 is a block diagram schematically showing a configuration example of the autonomous driving vehicle 1 according to a third embodiment. An overlapping description with the first embodiment will be omitted as appropriate. The autonomous driving vehicle 1 according to the present embodiment further has a seat belt detection device 40 in addition to the configuration described in the first embodiment. The seat belt detection device 40 is a sensor that detects that the user wears a seat belt of a seat on which the user sits.

According to the present embodiment, the following fourth condition is added to the departure condition.

(4) Fourth condition: the seat belt detection device 40 detects that the user wears the seat belt.

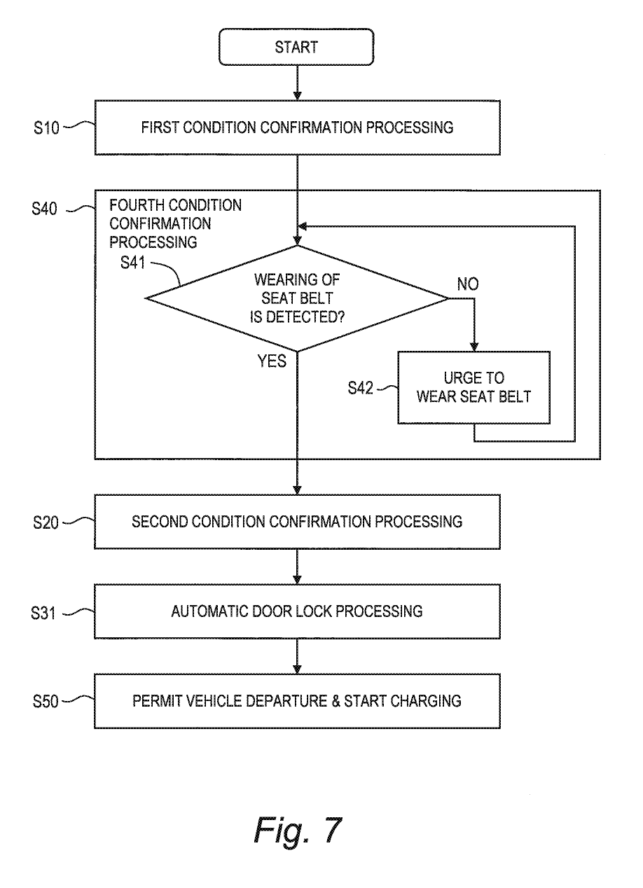

FIG. 7 is a flow chart showing an example of the departure condition confirmation processing according to the present embodiment. Step S40 (fourth condition confirmation processing) is added to the flow shown in the foregoing FIG. 3. More specifically, Step S40 is added between Step S10 and Step S20.

In Step S40, the control device 100 confirms that the fourth condition is satisfied. More specifically, the control device 100 determines whether or not the wearing of the seat belt is detected by the seat belt detection device 40 (Step S41). If the user does not yet wear the seat belt (Step S41; No), the control device 100 urges, through the HMI unit 60 (e.g. display device, speaker), the user to wear the seat belt (Step S42). When the wearing of the seat belt is detected (Step S41; Yes), the fourth condition is satisfied and Step S40 ends.

According to the present embodiment, the fourth condition that the user wears the seat belt is added to the departure condition. As a result, safety of the user increases. It should be noted that it is possible to combine the present embodiment with any of the first and second embodiments described above.

### 4. Fourth Embodiment

A fourth embodiment, which is a modification example of the third embodiment, relates to a case where the user cannot wear the seat belt for the user reason. For example, there may be a case where the user cannot wear the seat belt for the user's physical reason. In such a case, the user is exempted from the fourth condition by indicating exemption request intention. The exemption request intention of the user is received by the intention receiving device 20.

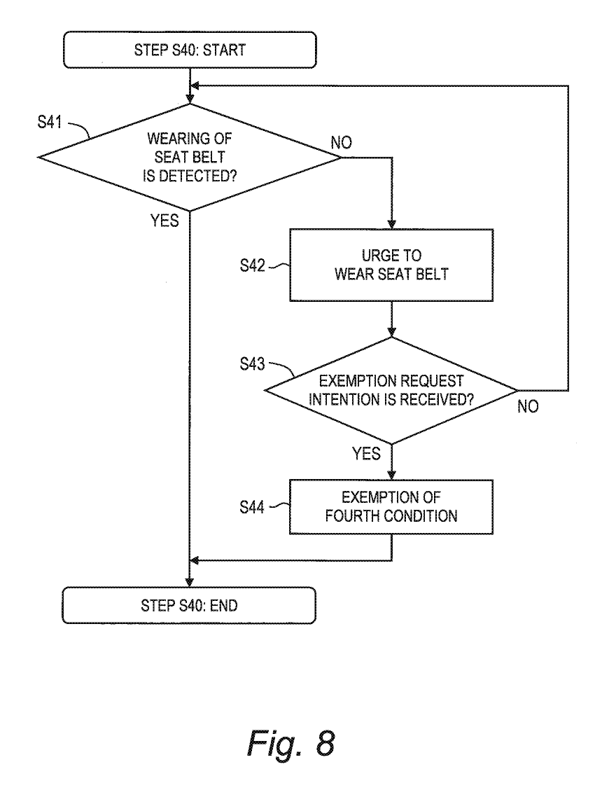

FIG. 8 is a flow chart showing Step S40 (fourth condition confirmation processing) in the present embodiment. Steps S41 and S42 are the same as in the third embodiment. After Step S42, the processing proceeds to Step S43.

If there is an exemption reason why the user cannot wear the seat belt, the user indicates exemption request intention to request exemption of the fourth condition. In Step S43, the control device 100 determines whether or not the intention receiving device 20 receives exemption request intention information indicating the exemption request intention of the user. When the intention receiving device 20 does not receive the exemption request intention information (Step S43; No), the processing returns back to Step S41. On the other hand, when the intention receiving device 20 receives the exemption request intention information (Step S43; Yes), the control device 100 excludes the fourth condition from the departure condition, that is, exempts the user from the fourth condition (Step S44).

According to the present embodiment, as described above, it is possible to exempt the user from the fourth condition if the user cannot wear the seat belt for the user reason. As a result, convenience is improved.

### 5. Fifth Embodiment

In a fifth embodiment, let us consider in particular a case where the number of the user is plural. In the case of the plurality of users, it is not necessary to confirm, in the departure condition confirmation processing, that the first condition and the second condition are satisfied with regard to all the users. It is enough to confirm that the first condition and the second condition are satisfied with regard only to a representative user among the plurality of users.

Moreover, in the case of the plurality of users, there may be a situation where a part of the users gets off at a halfway destination before a final destination. Hereinafter, let us consider the situation where a part of the users gets off at the halfway destination.

It should be noted that a plurality of destinations requested by the users may be beforehand included in the information of the dispatch request, or may be notified to the autonomous driving vehicle 1 from the user when boarding. Alternatively, every time the autonomous driving vehicle 1 arrives at a certain destination, the user may notify the autonomous driving vehicle 1 of a request for continued usage and a next destination. The intention receiving device 20 or the HMI unit 60 is used for information communication from the user to the autonomous driving vehicle 1.

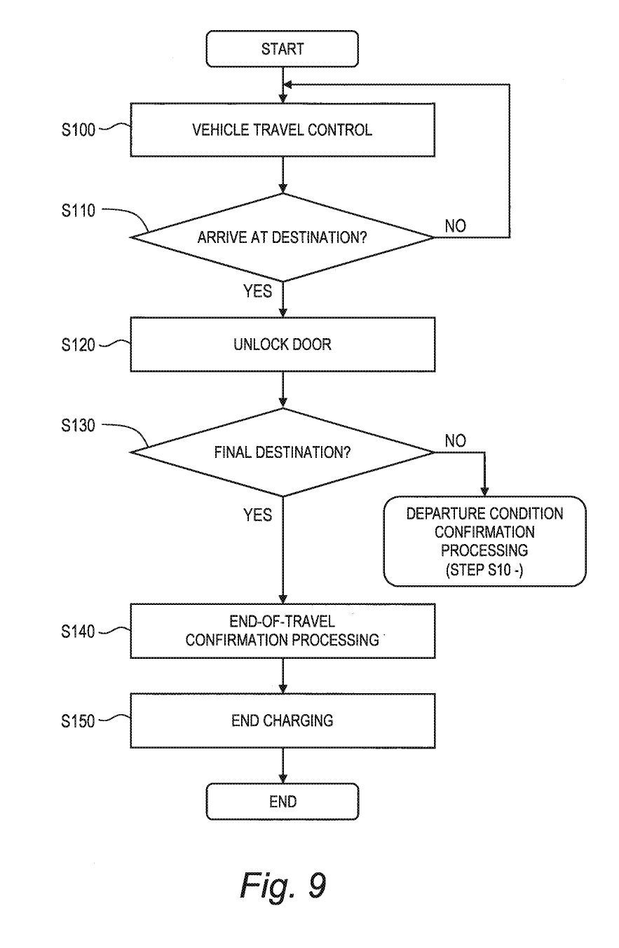

FIG. 9 is a flow chart showing processing by the autonomous driving vehicle 1 in the vicinity of a destination according to the present embodiment. Step S130 is added to the flow shown in the foregoing FIG. 4. More specifically, Step S130 is added between Step S120 and Step S140. An overlapping description with the foregoing embodiments will be omitted as appropriate.

In Step S130, the control device 100 determines whether or not the destination at which the autonomous driving vehicle 1 currently stops is the final destination. If the destination at which the autonomous driving vehicle 1 currently stops is the final destination (Step S130; Yes), the processing proceeds to the above-described Step S140. On the other hand, if the destination at which the autonomous driving vehicle 1 currently stops is not the final destination (Step S130; No), the autonomous driving vehicle 1 departs again to a next destination after a part of the users gets off. When maneuvering the autonomous driving vehicle 1 to depart again, the control device 100 performs the departure condition confirmation processing again.

It should be noted when the representative user gets off at the halfway destination, any of the remaining users who continues usage takes over the representative user. For example, the ID information of the previous representative user is passed to a terminal of the new representative user.

According to the present embodiment, as described above, the departure condition confirmation processing is performed also when a part of the plurality of users gets off along the way and then the autonomous driving vehicle 1 departs again. As a result, the same effects as in the foregoing embodiments can be obtained also when the autonomous driving vehicle 1 departs again.

### 6. Sixth Embodiment

It is also possible to combine some of the above-described embodiments as long as they are not contradictory to each other.

What is claimed is:

1. An autonomous driving vehicle that provides a driverless transportation service, comprising:
an authentication device that performs authentication of a user in the autonomous driving vehicle;
an intention receiving device that receives information indicating intention of the user in the autonomous driving vehicle; and
a control device that controls the autonomous driving vehicle, wherein
when maneuvering the autonomous driving vehicle to depart to a destination, the control device performs departure condition confirmation processing that prohibits the autonomous driving vehicle from departing until a departure condition is satisfied and permits the autonomous driving vehicle to depart when the departure condition is satisfied,
the departure condition including:
a first condition that the authentication of the user by the authentication device is completed; and
a second condition that the intention receiving device receives departure intention information indicating departure intention of the user.

2. The autonomous driving vehicle according to claim 1, wherein
the control device automatically locks a door of the autonomous driving vehicle before departure, in response to both the first condition and the second condition being satisfied.

3. The autonomous driving vehicle according to claim 1, further comprising a door lock detection device that detects that a door of the autonomous driving vehicle is locked, wherein
the departure condition further includes a third condition that the door lock detection device detects that the door is locked, and
the control device urges the user to lock the door when the third condition is not satisfied.

4. The autonomous driving vehicle according to claim 1, further comprising a seat belt detection device that detects that the user wears a seat belt of a seat on which the user sits, wherein
the departure condition further includes a fourth condition that the seat belt detection device detects that the user wears the seat belt.

5. The autonomous driving vehicle according to claim 4, wherein
exemption request intention information indicates intention of the user to request exemption of the fourth condition because the user cannot wear the seat belt for the user reason, and
the control device excludes the fourth condition from the departure condition when the intention receiving device receives the exemption request intention information.

6. The autonomous driving vehicle according to claim 1, wherein
a number of the user is plural,
the plurality of users include a representative user,
the first condition is that the authentication of the representative user by the authentication device is completed, and
the second condition is that the intention receiving device receives the departure intention information from the representative user.

7. The autonomous driving vehicle according to claim 6, wherein
the control device performs the departure condition confirmation processing again when maneuvering the autonomous driving vehicle to depart again after a part of the plurality of users gets off before a final destination.
